(19) United States
(12) Patent Application Publication
(10) Pub. No.: US 2019/0039940 A1
(43) Pub. Date: Feb. 7, 2019

(54) LASER CUTTING STRENGTHENED GLASS

(71) Applicant: Guardian Glass, LLC, Auburn Hills, MI (US)

(72) Inventors: Barry B. CORDEN, Detroit, MI (US); Alexey KRASNOV, Canton, MI (US)

(21) Appl. No.: 15/666,605

(22) Filed: Aug. 2, 2017

(51) Int. Cl. C03B 33/07; C03B 33/09; C03C 17/36; C03B 27/012; B23K 26/00; B23K 26/53

(52) U.S. Cl. CPC C03B 33/074; C03B 33/091; C03C 17/3644; C03C 17/3636; C03C 17/3605; C03C 17/366; B23K 2203/54; B23K 26/0057; B23K 26/0006; B23K 26/53; C03C 2217/256; C03C 2217/213; C03B 27/012

(57) ABSTRACT

A laser beam(s) is used to cut heat strengthened (e.g., thermally tempered) glass. The heat strengthened glass may be coated in certain example embodiments, such as with a multi-layer low-emissivity (low-E) coating and/or an antireflective (AR) coating. It has been found that focusing the laser beam(s) in a tensile stress zone, in a central area of the heat strengthened glass (as opposed to in a compression stress zone), during a cutting process provides for improved cutting characteristics to avoid and/or reduce fragmenting of the glass and to provide for a clean cut edge. The wavelength emitted from the laser may be tailored based on spectral characteristics of the coating.

Example embodiments of this invention relate to use of a laser(s) to cut heat strengthened (e.g., thermally tempered) glass. The glass may be coated in certain example embodiments. The coating on the heat strengthened glass may be, for example, a multi-layer low-emissivity (low-E) coating or an antireflective (AR) coating. The coating may be applied on the glass (e.g., via sputter-deposition) before and/or after the glass has been heat strengthened. It has been found that focusing the laser beam(s) in a tensile stress zone, in a central area of the heat strengthened glass (as opposed to in a compression stress zone), provides for improved cutting characteristics to avoid and/or reduce fragmenting of the glass and to provide for a clean cut edge. The wavelength emitted from the laser may be tailored based on spectral characteristics of the coating. In certain example embodiments, the cut glass may be used in applications such as monolithic or insulating glass (IG) building windows, vehicle windows, shower doors, or the like.

### BACKGROUND AND SUMMARY OF EXAMPLE EMBODIMENTS OF THE INVENTION

Coated articles are known in the art for use in window applications such as insulating glass (IG) window units, vehicle windows, monolithic windows, and/or the like. Example low-E coatings are disclosed, for example and without limitation, in U.S. Pat. Nos. 6,576,349, 9,212,417, 9,297,197, 7,390,572, 7,153,579, 9,403,345, 9,670,092, 9,475,727, 9,434,643, 9,422,626, 9,340,452, 9,302,936, 9,079,795, 7,267,879, 5,552,180, and 5,595,825, the disclosures of which are all hereby incorporated herein by reference. Such low-E coatings may be provided on, for example, glass substrate that may be heat strengthened (e.g., thermally tempered).

Thermally tempered soda-lime-silica based glass is known in the art. It is used in applications that require safety and/or increased durability. Such applications include vehicle windows, shower doors, sliding doors, residential and commercial windows, and so forth. Upon breaking, tempered glass shatters into small chunks rather than large shards, so that serious injuries to humans and animals can be prevented.

Thermal tempering, in general, is carried out by forced air quenching of hot glass. The glass is typically heated using temperature(s) of at least 580 degrees C., more preferably at least 600 degrees C., and most preferably at least 620 degrees C. The glass may be heated, for example, for at least 3 minutes, more preferably at least 5 minutes, and often at least 8 minutes. The hot glass may be hot glass exiting a lehr of a float line, or may be hot glass in a separate tempering location/facility distinct from the float line. During the air quenching, the glass surface is cooled down faster than the bulk of the glass and is put in a state of compression. Compressive stress caused by an increased glass density at the surface gives the tempered glass increased strength. At the same time, the interior of the glass remains under tension to counteract surface compression. The stress distribution across the glass thickness is represented by a parabola (see FIG. 2). Thus, the central area of the thermally tempered glass has tensile stress, whereas the outer areas near the major surfaces of the tempered glass have compressive stress. To maintain the balance, the total surface compression stress substantially equals that of the tension stress at the glass interior.

In existing float glass production practice, glass needs to be mechanically cut to customer-defined sizes and shapes before being thermally tempered, such as being mechanically scribed and then broken. Conventionally, attempts to cut thermally tempered glass with a mechanical tool or a laser have typically resulted in the glass shattering into small pieces.

U.S. Pat. No. 9,481,598 discloses a technique for cutting heat strengthened glass, and is incorporated herein by reference. The '598 patent discloses laser-cutting of strengthened glass by focusing the pulsed laser beam at the glass surface in the compressive stress area. The '598 patent, at column 15, lines 37-51, expressly teaches that one should “avoid focusing the laser in the tensile strained region . . . to avoid creating a defect or crack than can propagate uncontrollably.” Thus, the '598 patent teaches to focus the laser beam in the compressive stress area near the surface of the glass, and the “avoid” focusing the beam in the central tensile stress area. However, it has been found that, in truly tempered glass, focusing the laser beam at the glass surface in the region of compressive stress is a failure because once the surface crack is initiated by the laser beam it propagates through the entire thickness of the glass causing the glass to shatter. Thus, the technique described in the '598 patent does not work from a practical point of view, as it results in shattering of glass.

Thus, there exists a need in the art for processing large stock sheets of glass as far into the manufacturing process as possible, including being able to adequately cut heat strengthened (e.g., thermally tempered) glass. For instance, it would be desirable to be able to coat large-size glass sheets, then thermally temper them, and then cut the coated thermally tempered glass sheets in a manner that does not result in shattering of the tempered glass.

There are large groups of coatings that would significantly benefit from the ability to be deposited on annealed soda-lime-silica based float glass prior to thermal tempering, then thermally temper the coated glass, and then cut the coated tempered glass with a laser. Examples of such coatings include low-E coatings, which have a goal of reflecting near- and/or mid-infrared (IR) light to control heat transfer through glazing products, while allowing significant amounts of visible light to pass through. It would be economically desirable to (a) coat the glass, then temper the coated glass, and then cut the coated tempered large glass sheets to desirable sizes, compared to (b) coating, cutting to size, and then tempering.

Example embodiments of this invention relate to use of a laser(s) to cut heat strengthened (e.g., thermally tempered) glass. The glass may be coated in certain example embodiments, with a low-E coating or an AR coating. The coating may be applied on the glass (e.g., via sputter-deposition) before and/or after the glass has been heat strengthened. For cutting heat strengthened glass, it has surprisingly and unexpectedly been found that focusing the laser beam(s) in a tensile stress zone, in a central area of the heat strengthened glass (as opposed to in a compression stress zone), provides for improved cutting characteristics to avoid and/or reduce fragmenting of the glass during cutting and to provide for a clean cut edge. The wavelength emitted from the laser may be tailored based on spectral characteristics of the coating when a coating is provided. In certain example embodiments of this invention, the ability to laser cut coated glass that is heat strengthened (e.g., thermally tempered), allows one to coat large sheet glass, then temper the large coated sheet glass, and then cut the coated tempered large glass sheets to desirable sizes. In certain example embodiments, the cut tempered/coated glass may be used in applications such as monolithic or insulating glass (IG) building windows, vehicle windows, shower doors, or the like.

In an example embodiment of this invention, there is provided a method of cutting heat strengthened glass, the method comprising: having a sheet of heat strengthened glass comprising a compressive stress region and a tensile stress region, the compressive stress region being located between a first major surface of the glass and the tensile stress region; cutting the sheet of heat strengthened glass, said cutting comprising focusing a laser beam in the tensile stress region of the sheet of heat strengthened glass.

In an example embodiment of this invention, there is provided a method of making a coated article (e.g., for use in a window, sliding door, shower door, and/or the like), the method comprising: providing a coating on a first major surface of a sheet of glass; after providing the coating on the sheet of glass, thermally tempering the sheet of glass so as to provide a thermally tempered sheet of coated glass comprising a compressive stress region and a tensile stress region, the compressive stress region being located between the first major surface of the sheet of glass and the tensile stress region; and cutting the tempered sheet of coated glass, said cutting comprising directing a laser beam through the first major surface of the tempered sheet of glass and focusing the laser beam in the tensile stress region of the tempered sheet of glass.

### BRIEF DESCRIPTION OF THE DRAWINGS

FIG. 1 is a cross sectional view of a coated glass article, illustrating stress distribution in heat strengthened glass and a method of cutting the coated glass using a laser beam(s).

FIG. 2 is a cross sectional view illustrating stress distribution in heat strengthened glass, such as thermally tempered glass.

FIG. 3(a) is a cross sectional view of an example low-E coating that may be provided on the heat strengthened glass substrate in any of FIGS. 1-2.

FIG. 3(b) is a percent reflection versus wavelength (nm) graph illustrating the reflection/transmission characteristics of the low-E coating of FIG. 3(a).

FIG. 4 is a cross sectional view of an example antireflective (AR) coating that may be provided on the heat strengthened glass substrate in any of FIGS. 1-2.

### DETAILED DESCRIPTION OF EXAMPLE EMBODIMENTS OF THE INVENTION

Referring now to the drawings in which like reference numerals indicate like parts throughout the several views.

Coated articles herein may be used in applications such as monolithic windows for architectural or residential applications, IG window units, patio doors, vehicle windows, shower doors and/or any other suitable application that includes heat strengthened glass that has been cut.

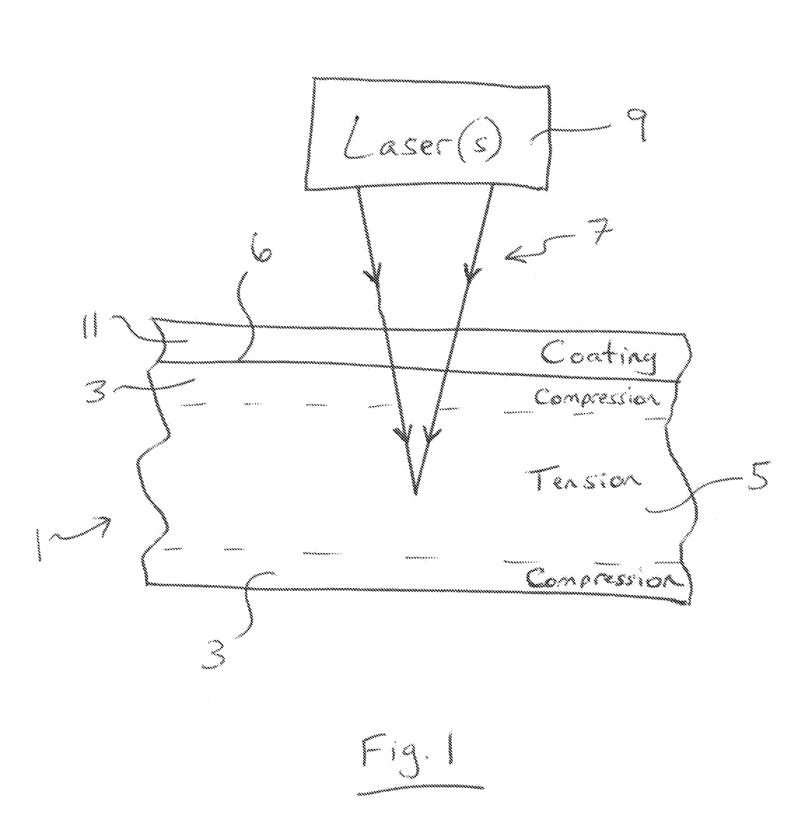

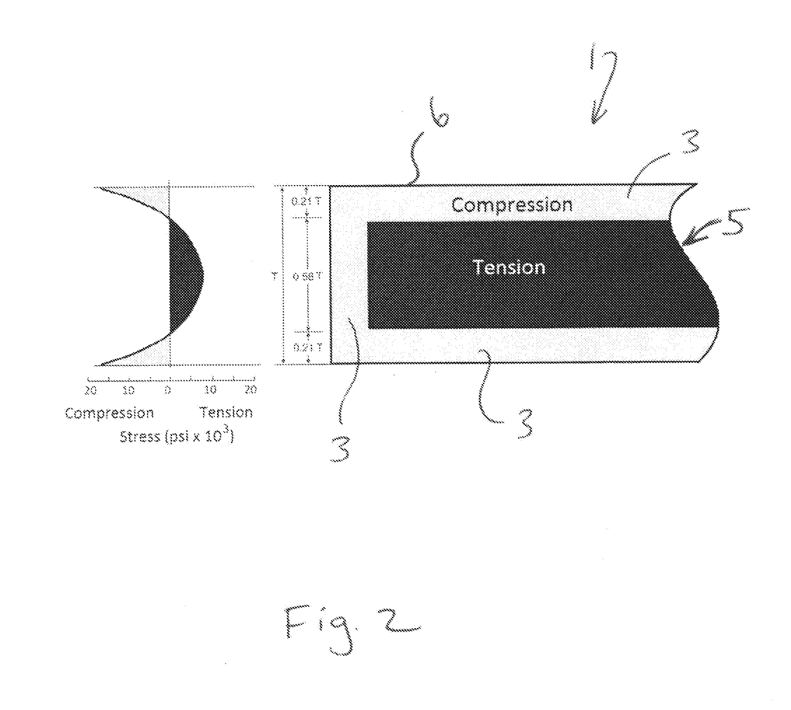

Example embodiments of this invention relate to use of a laser(s) to cut heat strengthened (e.g., thermally tempered) glass 1. The glass may be made via the float process, and thus may be soda-lime-silica based glass, in example embodiments of this invention. Thermal tempering, in general, is carried out by forced air quenching of hot glass. For thermal tempering, the glass is typically heated using temperature(s) of at least 580 degrees C., more preferably at least 600 degrees C., and most preferably at least 620 degrees C. The glass may be heated, for example, for at least 3 minutes, more preferably at least 5 minutes, and often at least 8 minutes. The hot glass may be hot glass exiting a lehr of a float line, or may be hot glass in a separate tempering location/facility/furnace distinct from the float line. During the air quenching, the glass surface is cooled down faster than the bulk of the glass and is put in a state of compression 3. Compressive stress caused by an increased glass density at the surface gives the tempered glass increased strength. At the same time, the interior or central area 5 of the glass remains under tension to counteract surface compression. The stress distribution across the glass thickness is represented by a parabola as shown in FIG. 2. As shown in FIG. 2, the tensile stress region 5 may begin about 20-21% of the way into the glass from the upper major surface thereof, and may end about 78-80% of the way through the thickness (T) of the glass 1. In other words, the compressive stress surface region 3 may be adjacent each surface of the glass 1 and may extend inwardly about 20-21% of the total glass thickness (T). As shown in FIG. 1, the compressive stress region 3, in an area between a first major surface 6 of the glass and the tensile stress region 5, has a thickness that is approximately 20-21% (e.g., 21%) of a total thickness of the glass. The word “approximately” as used herein means that value or range of values, plus/minus 10%. The tensile stress region 5 may have a thickness that is approximately 56-60% (e.g., 58%) of a total thickness of the glass 1, as shown in FIG. 1. Thus, as shown in FIGS. 1-2 and 4, the central area 5 of the thermally tempered glass 1 has tensile stress, whereas the outer areas 3 near the major surfaces of the tempered glass 1 have compressive stress. To maintain the balance, the total surface compression stress substantially equals that of the tension/tensile stress at the glass interior. The sheet of heat strengthened glass 1 may be thermally tempered and comprise a surface compression of at least 69 MPa (of at least 10,000 psi).

The instant inventors have found a way to cut heat strengthened (e.g., thermally tempered) glass 1, without the glass shattering in an uncontrollable manner. It has surprisingly and unexpectedly been found that focusing a laser beam(s) 7, emitted from a laser(s) 9, in a tensile stress zone/area 5, in a central area of the heat strengthened glass (as opposed to in a compression stress zone) 1, provides for improved cutting characteristics to avoid and/or reduce fragmenting of the glass during cutting and to provide for a clean cut glass edge. In certain example embodiments of this invention, the ability to laser cut coated glass that is heat strengthened (e.g., thermally tempered), allows one to coat large sheet glass, then temper the large coated sheet glass, and then cut the coated tempered large glass sheets to desirable sizes. The laser beam 7, focused in the tensile stress area 5 of the heat strengthened glass, may produce elongated microdefects or filaments within the glass. The filaments may, for example, be from 0.5-10 μm wide and/or from 1-1000 μm long, and may run normal to the two major glass surfaces. In certain example embodiments, the filament(s) may start under the defined upper limit of the tensile region (within the tensile region) and/or end before the other/lower limit of the tensile region on the opposite side of glass. Ideally, both ends of the filament (s) should be as close to the limits of the tensile region as possible. While the laser may cause such filaments to form in the glass, after irradiating the glass 1 with the laser beam(s) 7 the glass 1 may be fully separated/cut by applying modest mechanical force in certain example embodiments of this invention.

The glass 1 may be coated in certain example embodiments, with a low-E coating or an AR coating. The coating 11 may be applied on the glass (e.g., via sputter-deposition) before and/or after the glass has been heat strengthened, but is preferably applied prior to the cutting of the glass. An example coating 11 is a low-E coating including at least one IR reflecting layer (e.g., of or including silver) sandwiched between at least first and second dielectric layers of or including material(s) such as tin oxide, silicon nitride, silicon oxynitride, zinc stannate, and/or the like. Example low-E coatings that may be used for coating 11 are described, for example and without limitation, in U.S. Pat. Nos. 6,576,349, 9,212,417, 9,297,197, 7,390,572, 7,153,579, 9,403,345, 9,670,092, 9,475,727, 9,434,643, 9,422,626, 9,340,452, 9,302,936, 9,079,795, 7,267,879, 5,552,180, and/or 5,595,825, the disclosures of which are all hereby incorporated herein by reference. A purpose of a low-E coating 11 is to reflect near- and/or mid-infrared (IR) light to control heat transfer through glazing products to for example reduce heat transfer into buildings, while allowing significant amounts of visible light to pass therethrough. It is advantageous commercially and economically to be able to coat the glass, then temper the coated glass, and then cut the coated tempered large glass sheets 1 to desirable sizes, compared to having to cut the glass prior to tempering.

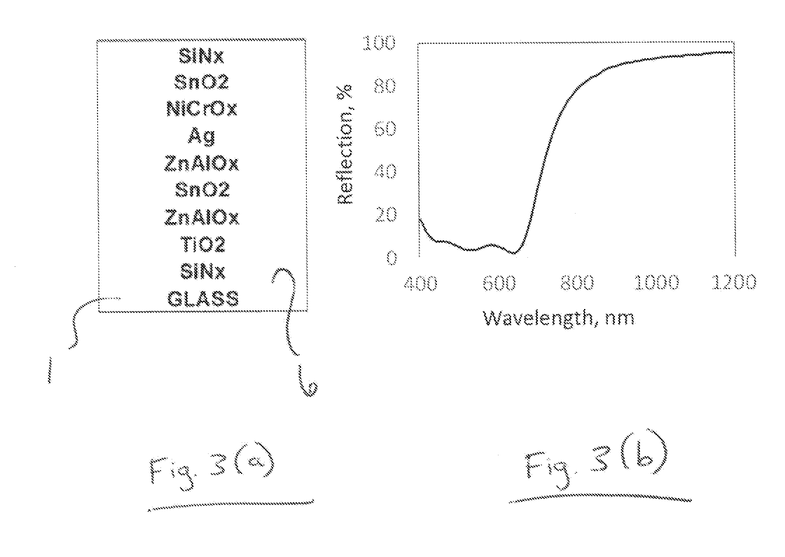

The wavelength emitted from the laser 9 (e.g., from about 250 to 1200 nm) may be tailored based on spectral characteristics of the coating 11 when a coating is provided. FIG. 3(a) is a cross sectional view of an example low-E coating 11 that may be provided on the heat strengthened glass 1 in any of FIGS. 1-2. Various layers of the low-E coating are shown in FIG. 3(a). And FIG. 3(b) is a percent reflection versus wavelength (nm) graph illustrating the reflection/transmission characteristics of the low-E coating 11 of FIG. 3(a). FIG. 3(b) illustrates that the coating 11 is highly reflective in the near-IR region, and is mostly transmissive in the visible region of the spectrum from about 400-640 nm. It can be seen from the spectrum shown in FIG. 3(b) that the use of lasers operating in the near-IR region would be undesirable for cutting low-E coated glass, since most of the laser radiation would be reflected by the coating 11. Certain example commercial laser systems operate at 1064 nm, and therefore are not preferred for cutting low-E coated glass, at least not from the coated side. Meanwhile, laser cutting from the bottom of the glass substrate (from the side opposite the coating 11) has technological limitations due to the conveying/roller method used in glass production/processing. And flipping the glass so as to be coated side down presents challenges such as an increased risk of scratching the coated surface. Moreover, in certain situations, both surfaces of the glass 1 may be coated with low-E stack(s). Thus, as discussed below, the wavelength(s) emitted from the laser 9 may be tailored based on spectral characteristics of the coating 11 when a coating is provided.

In certain example embodiments of this invention, laser cutting of the heat strengthened glass 1 includes using a short-burst pulsed laser 9 operating at the wavelength(s) where the coating 11 is substantially or mostly optically transparent. In the case of a low-E coating for example, the laser 9 may operate so as to emit a beam 7 in the visible region where low-E coatings are designed to be transparent. For example, the laser 9 may emit a beam 7 having a wavelength(s) from about 390-700 nm, more preferably from about 450-650 nm, and even more preferably from 500-600 nm, when cutting glass coated with a low-E coating. An example is a green laser operating at double frequency (half-wavelength) of that which may be used for filamentation cutting (e.g., 1064 nm). An example green wavelength is 532 nm.

The beam 7 is focused not just at the interior region of the glass, but specifically at its tensile zone 5 (e.g., see FIGS. 1-2 and 4 where the tensile zone 5 is the central region of the tempered glass covering the approximate three-fifth of the glass thickness). When the beam 7 is focused in the central region 5 where the tensile stress is present, a filament(s) is formed towards the opposite surface of the glass. One or more filaments may be required to cover the entire tensile region, depending on the total thickness of the glass.

There, there may be provided a method for short-burst pulsed filamentation laser cutting of coated thermally-tempered glass 1, including providing a thermally-tempered coated glass substrate where the coating 11 design and the laser operational wavelength are tailored to provide a minimum or reduced reflection of the laser beam and the maximum accuracy of focusing the laser beam 7 at the tensile stress region 5. This provides for forming a single filament or multiple (if single pass does not cover the entire thickness of the tensile region) filamentation pattern across the tensile region of the glass. Cleaving the laser-scribed glass may then be used for achieve complete separation between cut glass pieces. The laser 9 may be a pico-second short-burst green laser operating at about 532 nm in certain example embodiments, or may be a femto-second short-burst green laser operating at about 532 nm in other example embodiments, when low-E coating glass is being cut for example. The laser 9 may be an ultra-violet laser in certain example embodiments.

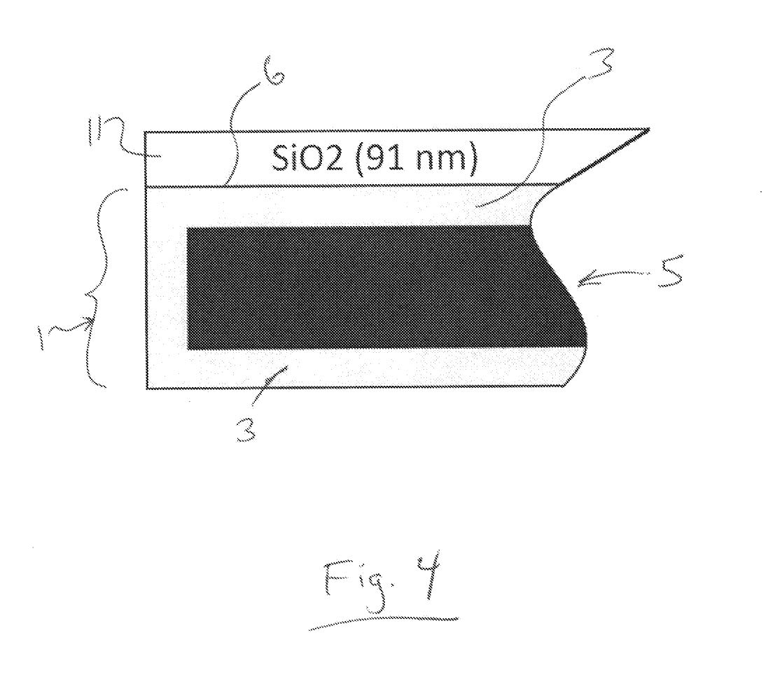

Due to a substantial difference in the optical refractive index between glass and air, a substantial amount of laser energy may be bounced off the glass substrate. In the case of tempered glass 1, the situation becomes even worse since the surface region of the tempered glass is under compression, and the refractive index difference is even greater due to the increased glass density. This further increases the amount of laser energy reflected from the glass and affects the precision of laser beam focusing. To address this issue, in certain example embodiments of this invention, an anti-reflection (AR) coating 11 is provided on the tempered glass 1 as best shown in FIG. 4 to mitigate the optical refractive index difference and facilitate the precise, or more precise, delivery of laser energy to the tensile region 5 for cutting. The AR coating 11 may be applied on the glass prior to the tempering step. Such an AR coating 11 may be as simple as a single quarter-wavelength (QWL) layer of a substantially optically-transparent material such as silicon oxide (e.g., SiO₂) as shown in FIG. 4. The QWL thickness depends on the operation wavelength of the laser and the refractive index of the anti-reflection material. For a 532 nm laser, an example coating could be a silicon oxide (SiO₂) thin film with refractive index of about 1.46 and an estimated QWL thickness of about 80-100 nm (e.g., about 91 nm). For a 1064 nm laser, that thickness may be approximately doubled to from about 170-200 nm (e.g., about 182 nm). In another example embodiment, the anti-reflection coating 11 may be a more complex multi-layer coating deposited on glass using any of a plurality of methods, such as sputter deposition or even wet deposition. The use of several thin films (e.g., alternative from high/low/high/low with respect to refractive index) results in better optically matching properties of the glass and the air and further reduces the amount of reflected light and uncertainty of the beam focusing. In yet another example embodiment, an anti-reflection coating 11 may be used on top of an inorganic or organic film, also serving to improve the film's mechanical and environmental durability. The optical design of a single- or multi-layer AR coating may be tuned to better match the wavelength of the laser. Example AR coatings that may be used for coating 11 include, for example and without limitation, those described in U.S. Pat. Nos. 9,163,150, 9,109,121, 8,693,097, 8,668,990, 8,617,641, 8,883,277, 7,833,629, and/or 8,372,513, the disclosures of which are hereby incorporated herein by reference.

In certain example embodiments, a monolayer anti-reflective coating 11 may be applied on thermally-tempered glass 1 prior to or after thermal tempering to facilitate the accurate transfer of laser energy into the tensile region of the glass (e.g., see FIG. 4). The anti-reflection coating 11 may have a refractive index between that of the air (˜1) and that the glass (˜1.53), more preferably from about 1.2 to about 1.5. The thickness of the AR coating 11 may be calculated using the following formula: t=λ/4n, where λ is the operational wavelength of the laser 9 and n is the index of the AR coating.

In an example embodiment of this invention, there is provided a method of cutting heat strengthened glass, the method comprising: having a sheet of heat strengthened glass comprising a compressive stress region and a tensile stress region, the compressive stress region being located between a first major surface of the glass and the tensile stress region; cutting the sheet of heat strengthened glass, said cutting comprising focusing a laser beam in the tensile stress region of the sheet of heat strengthened glass.

In the method of the immediately preceding paragraph, the laser beam may be directed so as to pass through the first major surface of the glass before focusing in the tensile stress region.

In the method of any of the preceding two paragraphs, said focusing the laser beam in the tensile stress region may cause at least one filament to form at least in the tensile stress region of the glass. The at least one filament may extend toward a second major surface of the glass that is opposite the first major surface.

The method of any of the preceding three paragraphs may further comprise, after said focusing the laser beam in the tensile stress region of the sheet of heat strengthened glass, applying mechanical force in order to fully separate pieces of the sheet.

In the method of any of the preceding four paragraphs, the sheet of heat strengthened glass may be thermally tempered.

In the method of any of the preceding five paragraphs, the method may comprise heating glass via temperature(s) of at least 580 degrees C. (more preferably at least 600 degrees, and most preferably at least 620 degrees C.) for at least 5 minutes (more preferably at least 8 minutes), and air quenching the heated glass, in order to provide the sheet of heat strengthened (e.g., thermally tempered) glass.

The method of any of the preceding six paragraphs may comprise emitting the laser beam from a short-burst pulsed laser.

In the method of any of the preceding seven paragraphs, the compressive stress region, in an area between the first major surface of the glass and the tensile stress region, may have a thickness that is approximately 20-21% of a total thickness of the glass.

In the method of any of the preceding eight paragraphs, the tensile stress region may have a thickness that is approximately 56-60% of a total thickness of the glass.

In the method of any of the preceding nine paragraphs, the laser beam preferably does not focus in any compressive stress region of the glass.

In the method of any of the preceding ten paragraphs, a coating may be provided on the first major surface of the glass substrate, prior to said cutting. The coating may be a low-E coating that comprises at least one infrared (IR) reflecting layer comprising silver that is located between at least first and second dielectric layers. The low-E coating may have a higher visible transmission in a visible region than in a near-IR region of the spectrum. The laser beam is tailored to the coating so that the laser beam may be primarily made up of wavelength(s) in the visible region of the spectrum when such a low-E coating is provided. For example, the laser beam may be primarily made up of wavelength(s) from 390-700 nm, more preferably from 450-650 nm, and most preferably from 500-600 nm (e.g., green laser beam). Alternatively, the coating may be an anti-reflective (AR) coating. Such an AR coating may comprise at least one layer comprising silicon oxide, and/or may consists essentially of a single approximately quarter wavelength layer of material (e.g., SiO₂) substantially transparent in the visible spectrum. A thickness (t) of an AR coating may be approximately characterized by t=λ/4n, where λ is the operational wavelength of a laser emitting the laser beam, and n is an index of the AR coating. The AR coating may also be a multi-layer coating. A layer of or including organic material may be provided between the glass and the AR coating.

In the method of any of the preceding eleven paragraphs, the sheet of heat strengthened glass may be thermally tempered and comprise a surface compression of at least 69 MPa (of at least 10,000 psi).

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of cutting heat strengthened glass, the method comprising:
having a sheet of heat strengthened glass comprising a compressive stress region and a tensile stress region, the compressive stress region being located between a first major surface of the glass and the tensile stress region;
cutting the sheet of heat strengthened glass, said cutting comprising focusing a laser beam in the tensile stress region of the sheet of heat strengthened glass.

2. The method of claim 1, wherein the laser beam passes through the first major surface of the glass before focusing in the tensile stress region.

3. The method of claim 1, wherein said focusing the laser beam in the tensile stress region causes at least one filament to form at least in the tensile stress region of the glass.

4. The method of claim 3, wherein the filament extends toward a second major surface of the glass that is opposite the first major surface.

5. The method of claim 1, further comprising, after said focusing the laser beam in the tensile stress region of the sheet of heat strengthened glass, applying mechanical force in order to fully separate pieces of the sheet.

6. The method of claim 1, wherein the sheet of heat strengthened glass is thermally tempered.

7. The method of claim 6, further comprising heating glass via temperature(s) of at least 580 degrees C. for at least 5 minutes, and air quenching the heated glass, in order to provide the sheet of thermally tempered glass.

8. The method of claim 6, further comprising heating glass via temperature(s) of at least 600 degrees C. for at least 5 minutes, and air quenching the heated glass, in order to provide the sheet of thermally tempered glass.

9. The method of claim 1, comprising emitting the laser beam from a short-burst pulsed laser.

10. The method of claim 1, wherein the compressive stress region, in an area between the first major surface of the glass and the tensile stress region, has a thickness that is approximately 20-21% of a total thickness of the glass.

11. The method of claim 1, wherein the tensile stress region has a thickness that is approximately 56-60% of a total thickness of the glass.

12. The method of claim 1, wherein the laser beam does not focus in any compressive stress region of the glass.

13. The method of claim 1, wherein a coating is provided on the first major surface of the glass substrate, prior to said cutting.

14. The method of claim 13, wherein the coating is a low-E coating that comprises at least one infrared (IR) reflecting layer comprising silver that is located between at least first and second dielectric layers.

15. The method of claim 14, wherein the low-E coating has a higher visible transmission in a visible region than in a near-IR region of the spectrum.

16. The method of claim 15, wherein the laser beam is primarily made up of wavelength(s) in the visible region of the spectrum.

17. The method of claim 14, wherein the laser beam is primarily made up of wavelength(s) from 390-700 nm.

18. The method of claim 14, wherein the laser beam is primarily made up of wavelength(s) from 450-650 nm.

19. The method of claim 14, wherein the laser beam is primarily made up of wavelength(s) from 500-600 nm.

20. The method of claim 13, wherein the coating is an anti-reflective (AR) coating.

21. The method of claim 20, wherein the AR coating comprising at least one layer comprising silicon oxide.

22. The method of claim 20, wherein the coating consists essentially of a single approximately quarter wavelength layer of material substantially transparent in the visible spectrum.

23. The method of claim 20, wherein a thickness (t) of the AR coating is approximately characterized by t=λ/4n, where λ is the operational wavelength of a laser emitting the laser beam, and n is an index of the AR coating.

24. The method of claim 20, wherein the AR coating is a multi-layer coating.

25. The method of claim 20, wherein a layer comprising organic material is provided between the glass and the AR coating.

26. The method of claim 1, wherein the laser beam is a green laser beam.

27. The method of claim 1, wherein the sheet of heat strengthened glass is thermally tempered and comprises a surface compression of at least 10,000 psi.

28. A method of making a coated article, the method comprising:
providing a coating on a first major surface of a sheet of glass;
after providing the coating on the sheet of glass, thermally tempering the sheet of glass so as to provide a thermally tempered sheet of coated glass comprising a compressive stress region and a tensile stress region, the compressive stress region being located between the first major surface of the sheet of glass and the tensile stress region; and
cutting the tempered sheet of coated glass, said cutting comprising directing a laser beam through the first major surface of the tempered sheet of glass and focusing the laser beam in the tensile stress region of the tempered sheet of glass.

29. The method of claim 28, wherein said focusing the laser beam in the tensile stress region causes at least one filament to form at least in the tensile stress region of the glass, wherein the filament extends toward a second major surface of the glass that is opposite the first major surface.

30. The method of claim 28, wherein the coating is a low-E coating that comprises at least one infrared (IR) reflecting layer comprising silver that is located between at least first and second dielectric layers.

31. The method of claim 30, wherein the laser beam is primarily made up of wavelength(s) in the visible region of the spectrum.

32. The method of claim 30, wherein the laser beam is primarily made up of wavelength(s) from 450-650 nm.

33. The method of claim 30, wherein the laser beam is primarily made up of wavelength(s) from 500-600 nm.

34. The method of claim 30, wherein the tempered sheet of coated glass comprises a surface compression of at least 10,000 psi.

35. The method of claim 28, wherein the tempered sheet of coated glass comprises a surface compression of at least 10,000 psi.
